(19) United States
(12) Patent Application Publication
(10) Pub. No.: US 2013/0151274 A1
(43) Pub. Date: Jun. 13, 2013

(54) METHOD AND APPARATUS FOR ENHANCING HOME HEALTHCARE

(71) Applicants: Michael D. Bage, Akron, OH (US); Eric A. Espinal, Akron, OH (US); Hitesh Makkar, Akron, OH (US)

(72) Inventors: Michael D. Bage, Akron, OH (US); Eric A. Espinal, Akron, OH (US); Hitesh Makkar, Akron, OH (US)

(21) Appl. No.: 13/668,275

(22) Filed: Nov. 4, 2012

Related U.S. Application Data
(60) Provisional application No. 61/555,914, filed on Nov. 4, 2011.

(51) Int. Cl. G06F 19/00

(52) U.S. Cl. CPC G06F 19/3462
USPC 705/2

(57) ABSTRACT

A home healthcare system includes a patient monitoring device, a therapy delivery device, a local storage device, and a communication device. The patient monitoring device monitors a physiological condition of a patient in a home or home-like environment. The therapy delivery device holds a prescribed therapy for medical treatment of the patient in the home or home-like environment and selectively delivers a prescribed dosage of the prescribed therapy to the patient. The local storage device stores information associated with the patient. The communication device provides a user interface to the patient and a communication interface with a communication network outside the home or home-like environment to enable establishment of a communication session to/from another communication device associated with another party. Various methods for using the system to enhance home healthcare include monitoring a physiological condition of the patent and delivering a prescribed dosage of a prescribed therapy to the patient.

This application is based on and claims priority to U.S. Provisional Application No. 61/555,914, filed Nov. 4, 2011, which is incorporated herein by reference in its entirety.

### BACKGROUND

This disclosure relates to a process for enhancing home healthcare using a system that includes a patient monitoring device and a communication device for monitoring a physiological condition of a patent in a home or home-like environment. The system also includes a therapy delivery device and delivering a prescribed dosage of a prescribed therapy to the patient in the home or home-like environment. The communication device provides a user interface to the patient and a communication interface with a communication network outside the home or home-like environment to enable communication sessions to/from another communication device associated with an authorized healthcare provide, another party, or a remote storage device. While various methods for using the system to enhance home healthcare are described, it is understood that the system may be used to provide other services related to home healthcare. For example, various embodiments of the methods and apparatus described herein may be used in conjunction with services related to controlling diet, food consumption, and substance abuse.

Over the past several years the cost of healthcare in the United States has been continuously increasing. Studies have shown that since 1990, the United States expenditures on health care has nearly tripled and surpassed $2.3 trillion in 2008. The rising costs of healthcare are a problem that needs to be addressed in order to reduce the financial burden on the government, employers and consumers. In an effort to contain costs, investments need to be made in information technology systems to allow for better communication between patients and physicians. During the Obama administration, the government provided $19 billion in federal funding to uniformly upgrade health information technology (IT). Additionally, the healthcare system must reorganize priorities so that patient quality and efficiency are taken into account. Some experts estimate that up to 30% of health care is unnecessary. This emphasizes the need to streamline the healthcare system and eliminate needless spending.

Baby boomers, defined by the U.S. Census Bureau as 78.2 million Americans born between 1946 and 1964, are living longer and staying healthier than previous generations. As baby boomers age, the number of American aged 65 and above is expected to grow more than twofold, from 35 million in 2000 to 72 million by 2030.

Medical care in the United States is estimated at 16% of the gross domestic product. Of each dollar spent on health care in the United States 31% goes to hospital care. As the country is moving towards pay for performance and outcomes, keeping patients out of the hospital would result in significant cost savings for the hospitals and insurance companies.

There is a healthcare crisis in America. The population is aging and the prevalence of costly chronic disease is on the increase. The government, society, and individual patients are facing difficult choices in determining how to allocate limited healthcare dollars in the face of escalating cost and increased demand for services.

Healthcare costs have been rising for several years. According to published Kaiser Foundation data, expenditures in the United States on healthcare surpassed $2.3 trillion in 2008, more than three times the $714 billion spent in 1990, and over eight times the 253 billion spent in 1980. In 2008, U.S. healthcare spending was estimated at $7,681 per resident. This amount was 16.2% of the nation's gross domestic product (GDP). This percentage of GDP was among the highest of all industrialized countries in 2008. Many experts and policymakers project that healthcare costs will continue to escalate unless new measures are taken. Family premiums for employer-sponsored private health insurance coverage have increased by 131% since 1999. With premium costs increasing more rapidly than real wages, workers and employers alike are experiencing economic pressure. The current economic climate has also resulted in a growing percentage of the US population uncovered by private health insurance. While Medicaid expenditures had been growing at a slightly slower rate than private medical spending, this will likely change as the current economic recession has resulted in increased enrollments in government subsidized health programs.

The recent economic downturn, rising federal deficit, and continued escalation of healthcare expenditures by the federal government has brought into question the future solvency of the Medicare and Medicaid systems. Control of escalating healthcare costs has been cited by many analysts as a key factor in achieving broader economic stability and growth. The Obama administration has made cost control a focus of healthcare reform efforts and the CMS has developed new policies aimed at hospitals and physicians.

In 2008, hospital care and physician/clinical services combined made up 51% of the nation's healthcare expenditures. There are a number of factors contributing to the rise in healthcare costs. An aging population with longer life spans and a greater prevalence of chronic illness placed tremendous demands on the healthcare system and upon society's ability to pay for healthcare. Patients with certain medical conditions are associated with a particularly high utilization of healthcare dollars. These include conditions such as congestive heart failure (CHF), diabetes, as well as chronic lung diseases, such as chronic obstructive pulmonary disease (COPD) and asthma. In an attempt at cost containment, the CMS plans to hold hospitals and physicians financially accountable for the outcomes of patients with certain high utilization health conditions. Payments to health care institutions and providers will be cut or withheld under certain circumstances such as re-hospitalization within a designated time period or failure to reach certain therapeutic metrics.

CHF, for example, is the most common Medicare Diagnosis Related Group (DRG) and accounts for more healthcare costs than any other disease condition. It has been estimated that the total annual US healthcare expenditure for both direct and indirect associated healthcare costs of CHF approaches $28 million. CHF re-admissions contribute significantly to this expenditure. CMS is targeting costly CHF re-admissions through a proposed financial penalty levied against hospitals. The rate of CHF re-admissions has increased from 16.8% in 2002 to 24.8% in 2008 while adherence to medication treatment guidelines has improved during the same time.

Another highly prevalent chronic disease is diabetes. This condition affects 18.2 million Americans. Diabetics as a whole have an increased risk of hospitalization compared to non-diabetics. Diabetics have a greater risk of developing certain complications including cardiovascular disease, such as heart disease and stroke, as well as extremity amputation. The risk of hospitalization for treatment of cardiovascular disease is between two to four times higher for women with diabetes as compared to non-diabetic women. Diabetics also experience increased risk of renal failure, blindness, and infection. It has been shown that healthcare costs are three times higher for diabetic patients with multiple hospitalizations as compared to diabetic patients with a single stay in a given year. Early intervention to prevent re-hospitalization is therefore warranted. According to the US Department of Health and Human Services website appropriate primary care for diabetes complications could save Medicare an estimated $1.3 billion in total costs and save Medicaid $386 million in total costs.

The National Heart, Lung, and Blood Institute (NHLBI) estimated the total (direct plus indirect) annual cost of COPD in the US to have been $38.8 billion in 2005. An estimate from the 2000 Medical Expenditure Panel Survey suggested that more than one half of the cost associated with the treatment of COPD was related to hospitalization. The Asthma and Allergy Foundation of America (AAFA) estimates that one in 15 Americans suffers from asthma with a steadily increasing prevalence since the 1980s. Asthma is the most common chronic condition among children. Nearly 44% of all asthma hospitalizations are for children. Asthma is common across all age and ethnic groups and accounts for one quarter of all US emergency room visits. The AAFA quotes direct annual US asthma associated costs as nearly $10 billion (with hospitalizations as the single largest portion of direct costs) and indirect costs of $8 billion.

The successful treatment of multiple medical conditions that include but are not limited to CHF, COPD, asthma and diabetes mellitus (DM) require intensive medical therapy on an outpatient and inpatient basis. In order to accurately diagnose and treat various conditions, physicians need to be able to continuously monitor a patient's blood pressure, heart rate, oxygen levels, weight and medication regimens. Traditionally, routine office visits are the only time at which physicians can check a patient's condition, collect blood and other samples, and measure vital signs. This strategy is limited when a patient's clinical condition changes outside of the office. If recommended treatment begins to fail, it might not be detected and corrected until the next office visit, which may be two, four, or six weeks in the future.

Treatment requires accurate diagnosis and the implementation of therapy that is chronic and ongoing in nature. Appropriate treatment requires careful monitoring of a patient's condition. Although this is traditionally done on an outpatient basis through routine office visits with a patient's physician, recent data has shown improved outcomes with more frequent visits at the patient's home. Moreover, compliance with prescribed medical therapy can be limited because of poor patient understanding, clinical changes in a patient's condition that may not he detected until the next office visit, and unanswered questions that occur on a daily basis regarding medications, diet, activity, and lifestyle.

Current outpatient treatment of chronic problems typically consists of outpatient visits to a physician's office with treatment recommendations made based on the clinical evaluation at a certain point in time. The usefulness of this strategy is somewhat limited in its ability to respond when a patient's clinical condition changes. The usefulness of the office follow-up strategy for outpatient check-ups is also somewhat limited when an elderly patient becomes confused about a complex medicine regimen. Its usefulness is also somewhat limited when the recommended treatment begins to fail between office visits, which may be scheduled in two, four, or six weeks intervals.

Adherence to prescribed medication regimens can be difficult for patients and particularly challenging for the elderly. Moreover, timely, accurate compliance data is often not at the practitioner's disposal. Factors that lead to medication errors in the home include: 1) Multiple ‘prescriptions; 2) Poor lighting and poor vision; 3) Cluttered medicine cabinets that hold expired medications; 4) Duplicate therapy as a result of self-medicating; 5) Consulting multiple physicians and not providing a complete medical history; 6) Dementia or confusion; 7) Overuse of “as needed” medications; and 8) Sharing medications with other family members.

Due to these factors, it is estimated that the true rate of adherence to medication regimens is only about 50%. It is very difficult to maintain dosage intervals within the prescribed limits, adhere strictly to administration times, almost never miss a prescribed dose, and only occasionally take an extra dose. The consequences of medication non-adherence in the elderly are profound. In one study by Col, 315 patients 65 years of age and older were interviewed upon hospital admission. Twenty eight percent of admissions were drug related, with eleven percent being the result of non-adherence and 17% caused by adverse drug reactions. See, e.g., Col et al., The Role of Medication Non-compliance and Adverse Drug Reactions in Hospitalizations of the Elderly, Arch Intern Med, 1990, Vol. 150, pp. 841-845, the contents of which are fully incorporated herein by reference. As a result, hospitalization, re-hospitalizations and nursing home admissions are recognized as direct costs of medication non-adherence in the elderly. According to a Boston-based health policy group, individuals that don't take their medications as prescribed cost the healthcare system up to $290 Billion per year.

Unfortunately, hospitals and physicians do not currently possess a widely available mechanism to adequately monitor outpatient compliance and behavior that directly impacts the rate of relapse and re-hospitalization in chronic disease states. Small pilot programs have been proven labor-intensive and yet successful in both the reduction in hospitalization rate and overall cost savings. Programs utilizing methods as simple as follow-up nurse phone calls to patients have been proven beneficial. A recently published study performed by the Department of Family and Community Medicine at the University of California Davis School of Medicine concluded “substantial reductions in hospital re-admissions, emergency visits, and cost of care for patients with CHF might be achieved by widespread deployment of distance technologies to provide post hospitalization monitoring.”

Regardless of the disease state under treatment, medication noncompliance contributes significantly to healthcare costs. The Boston-based New England Healthcare Institute published a study in 2009 that found that from ⅓ to ½ of patients the United States do not take their medications as their doctors had intended. It was found that these individuals “pay a price in poorer health, more frequent hospitalizations, and a higher risk of death.” The study further stated that patients who did not take their medications as prescribed incur up to $290 billion annually in increased medical costs.

For these and other reasons, there is a need for improvements in outpatient and home healthcare devices that are more tightly integrated with authorized healthcare providers so that care of patients has more comprehensive and timely treatment, monitoring, and adjustments to treatment than current devices and practices.

### SUMMARY

In one aspect, an apparatus for enhancing home healthcare is provided. In one embodiment, the apparatus includes: a patient monitoring device configured to monitor a physiological condition of a patient in a home or home-like environment; a therapy delivery device configured to hold an inventory of a prescribed therapy for medical treatment of the patient in the home or home-like environment and to selectively deliver a prescribed dosage of the prescribed therapy to the patient; a local storage device configured to at least temporarily store information associated with the physiological condition of the patient, information associated with the prescribed therapy for the patient, and information associated with the medical treatment of the patient; and a communication device in operative communication with the patient monitoring device, therapy delivery device, and local storage device and configured to provide a user interface to the patient in conjunction with utilization of the patient monitoring device and therapy delivery device, wherein the communication device is also configured to provide a communication interface with a communication network outside the home or home-like environment to enable establishment of a communication session to/from another communication device associated with another party.

In another aspect, a method for enhancing home healthcare is provided. In one embodiment, the method includes: receiving information associated with a prescribed therapy for medical treatment of a patient using a therapy delivery device in a home or home-like environment, wherein the information associated with the prescribed therapy is received at a communication device and at least temporarily stored in a local storage device; receiving an inventory of the prescribed therapy at the therapy delivery device, wherein the therapy delivery device is configured to hold the inventory and to selectively deliver a prescribed dosage of the prescribed therapy to the patient; determining a prescribed dosage of the prescribed therapy needs to be delivered to the patient based at least in part on the information associated with the prescribed therapy; controlling the therapy delivery device from the communication device to dispense the prescribed dosage of the prescribed therapy from the inventory to a collection tray associated with the therapy delivery device in accordance with a predetermined schedule; and providing an alert indication at a user interface associated with the communication device to indicate the prescribed dosage of the prescribed therapy is dispensed to the collection tray and ready for removal.

In yet another aspect, a method for enhancing home healthcare is provided. In one embodiment, the method includes: receiving information associated with a physiological condition of a patient and with use of a patient monitoring device in a home or home-like environment to monitor the physiological condition, wherein the information is received at a communication device and at least temporarily stored in a local storage device; determining a measurement of the physiological condition of the patient needs to be obtained based at least in part on the information associated with the physiological condition; providing an alert indication at a user interface associated with the communication device to indicate the patient monitoring device needs to be used to obtain the measurement of the physiological condition of the patient; controlling the user interface and the patient monitoring device from the communication device to set up the patient monitoring device for the needed measurement; and obtaining the measurement of the physiological condition of the patent from the patient monitoring device at the communication device.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a functional block diagram of an exemplary embodiment of a device to carry out aspects of the disclosure;

FIG. 2 is a functional block diagram of an exemplary embodiment of a device connected to an application specific device;

FIG. 3 is a functional black diagram of another exemplary embodiment of a device connected to an application specific device;

FIG. 4 is a functional block diagram of yet another exemplary embodiment of a device connected to an application specific device;

FIG. 5 is a front view of an exemplary embodiment of a medication dispensing system;

FIG. 6 is a cross-sectional view of an exemplary embodiment of a medication cartridge for a medication dispensing system;

FIG. 7 is a perspective view of an exemplary embodiment of a travel box for a medication dispensing system;

FIG. 8 is a block diagraph of an exemplary embodiment of a home healthcare system;

FIG. 9 is a block diagram of another exemplary embodiment of a home healthcare system;

FIG. 10 is a functional block diagram of an exemplary embodiment of a therapy delivery device for a home healthcare system;

FIG. 11 is a functional block diagram of another exemplary embodiment of a therapy delivery device for a home healthcare system;

FIG. 12 is a flow chart of an exemplary embodiment of a process for enhancing home healthcare;

FIG. 13, in conjunction with FIG. 12, is a flow chart of another exemplary embodiment of a process for enhancing home healthcare;

FIG. 14, in conjunction with FIG. 12, is a flow chart of yet another exemplary embodiment of a process for enhancing home healthcare;

FIG. 15, in conjunction with FIGS. 12 and 14, is a flow chart of still another exemplary embodiment of a process for enhancing home healthcare;

FIG. 16, in conjunction with FIGS. 12 and 14, is a flow chart of still yet another exemplary embodiment of a process for enhancing home healthcare;

FIG. 17 is a flow chart of another exemplary embodiment of a process for enhancing home healthcare; and

FIG. 18, in conjunction with FIG. 17, is a flow chart of yet another exemplary embodiment of a process for enhancing home healthcare.

### DETAILED DESCRIPTION

Telemedicine literally means providing medical care at a distance. It is seen to be an integration of telecommunications, information, human-machine interface and medical-care technologies for enhancing the delivery of healthcare. Telemedicine may range from telephonic discussion between two physicians on a particular case to the exchange of patient data and images on computer networks to remote patient examination using video conferencing equipment. Telemedicine has become an integral part of the healthcare system and is set to change the healthcare landscape in the years to come. Baby boomers, with their tendency to embrace both better lifestyles and new technologies, are expected to continue being a strong driver for growth of the telemedicine market.

One of the major components that telemedicine relies on is wireless technology. Wireless home-based health monitoring have long been an idea that companies and universities have been deliberating on, but it is only now with the evolution and easy deployment of cheap and efficient wireless communication techniques that wireless monitoring has received the industrial recognition making it a key technology for the future. The market for this technology caters to both hospital care and homecare segments. Bluetooth is an emerging wireless personal area networking (WPAN) technology that complements wireless LANs and is expected to coexist with them. Bluetooth technology provides wireless connection between devices at distances up to 100 m. Typically, devices using Bluetooth technology are less than five or ten meters apart. Early versions of Bluetooth technology can achieve 1 Mbps data rates; later version can reach higher data rates. Bluetooth is a small form-factor, low-cost radio solution that provides links between mobile phones, mobile computers and portable handheld devices along with connectivity to the Internet.

The progression of telemedicine is driven by four key aspects. First, cost of treatment for a patient has continuously risen over the past few decades. Telemedicine is an effective way to interact with a patient by breaking the barriers of distance and time. Based on the information that is transmitted to the physicians, instructional feedback can be reported to the patient sitting at home. Avoiding the physical costs of driving and attending an appointment will cut healthcare costs immensely. Secondly, due to a shortage of physicians and nurses in the healthcare sectors, telemedicine is helping medical personnel save time on operational activities and devote more time to patient care. Telemedicine will allow physicians to handle a higher volume of patients increasing efficiency and productivity. Thirdly, telemedicine will be driven by the constant change of technological innovation. Every day newer technologies emerge that motivate patients to utilize better devices. Easier operability and advanced user interfaces will provide patients with an easy way to communicate with their physicians regardless of geographical location. Finally, because many patients live in less populated areas where hospital care is not available, telemedicine will provide a life line of support that will give patients a better peace of mind in terms of their overall health.

While telemedicine has the potential to lower costs and improve the efficiency of patient care, a major barrier will have to be handled before these applications can become effective. The barrier Acceptance of the quality of care that will be provided is the barrier and provides the main challenges facing this sector. Patients who are used to seeing physicians for treatment at a clinic or hospital settings have to be persuaded to use a telemedicine solution, to connect with a doctor for a live interactive session. A psychological factor is present here that must be dealt with since discussing your condition via a web communication is far different than speaking with a doctor in person.

In an attempt to relay critical patient information to the physicians in real time, a medical application is disclosed herein that may help reduce hospitalization and increase compliance with recommended medical therapy. An exemplary embodiment of the healthcare application focuses on medication schedules and regimens. For example, the healthcare application may include features that allow physicians to track and record whether a patient is adhering to the medication regimen that was prescribed. In further embodiments, the healthcare application may include features that allow patients to better comply with a medication regime. In even further embodiments, the healthcare application may include features that allow more frequent monitoring of patient data without requiring the patient's physical presence in the clinical facility.

While the disclosure envisions the system to be created and distributed primarily as a downloaded smart-phone application or “app,” for example an iOS, Android OS, Blackberry and Windows Mobile, those skilled will appreciate that the system could be provided with hardwired circuitry, on stand-alone devices, or on other mobile or stationary or wireless or wire line computing platforms such as tablets, PDA's, laptops, desktops, vehicle-based systems and the like.

An exemplary embodiment of an interactive, computer-based application (e.g., a home or remote healthcare application) can provide a personalized, comprehensive, in-home system to improve the understanding, treatment and compliance with recommended therapies for patients with congestive heart failure. The system may be based on an Apple iPad2 platform or other similar computer platform. The healthcare application may provide support in a variety of ways.

For example, the system, in conjunction with the healthcare application, can track and dispense prescribed medications via a wireless (e.g., Bluetooth) or wired medicine dispenser. In relation to the medicine dispenser, the healthcare system can remind a patient to take medication and maintain a desired inventory of prescribed medications. The system can provide a physician with a report regarding patient compliance with prescribed medications. The system can also notify designated family members and/or physicians of missed doses. In particular, the system can limit patient confusion in relation to multiple medications.

The system, in conjunction with the healthcare application and various wireless (e.g., Bluetooth) or wired patient monitoring devices, can record clinical data that can be stored locally and/or in a central location in a manner that is accessible to a monitoring healthcare provider. The data may alternatively or also be forwarded to a designated monitoring healthcare professional. The system may include any combination of various patient monitoring devices, such as a scale, a blood pressure cuff, a heart rate monitor, a peak flow meter, an electrocardiogram (EKG) monitor, an oximeter, and other suitable types of monitors for monitoring a patient condition in a home or remote environment.

The system, in conjunction with the healthcare application and various wireless or wired patient communication devices can enable personal interaction and discussions between a patient and a healthcare professional. For example, the system may include audio and video components to use a voice over IP (VoIP) service, such as Skype, for such communications. Alternatively, the system may use any suitable combination of Internet, telephone, radio, and video communication services for such communication, including IP telephone, landline telephone, cellular telephone, and satellite telephone. The communication devices and services allow the system to be used for frequent and/or timely interactions that can answer questions, provide encouragement, and more powerfully engage patients in their daily care. Frequent check-ins without an office visit allows more careful follow-up of a patient and more timely adjustments of treatment. In addition, opportunities to prevent de-compensation of these chronic conditions may limit the need for repeated hospital admissions. Avoiding re-admissions may save hospitals, insurance companies and taxpayers a significant amount of money.

In certain embodiments, the system for the healthcare application can be implemented using hardware, including a computer platform, computer peripheral devices, and medical devices and equipment that are commercially available. In other embodiments, some of the commercially available devices and equipment may need to be modified for integration into the system and/or the healthcare application. In still further embodiment, the system for the healthcare application may be implemented using some custom hardware that is integrated with other commercially available hardware and/or the healthcare application to form the system.

The system, in conjunction with the healthcare application, can provide real-time and/or near real-time feedback using interactive communication technologies. This personal interaction is patient-specific and is provided with the patient at their home. A more careful, timely, and individual care plan can be provided which will improve overall outcomes in performance status, quality of life, avoidance of hospitalization, and overall compliance with recommended medical therapy. Real time data may allow an entire team of medical providers (physician, nurse practitioners, and other support personnel) to provide pertinent advice, encouragement, and answer questions as often as may be necessary to provide a greater level of support and engagement.

Subscriptions could allow access to medical professionals at different tiers corresponding to an individual patient's desire and the clinical needs and indications. Insurance companies may be motivated to use the system with the healthcare application because the “medical home” approach to healthcare (providing care to patients at their residence rather than at the doctor's office) is associated with better patient satisfaction, improved compliance, and better outcomes—including a reduction in hospital stays. Given that the Center for Medicare and Medicaid Services (CMS) may be compensating hospitals on pay for performance, preventing admissions for the same chronic diagnosis may save hospitals millions of dollars.

In another embodiment, this disclosure provides a universal program platform which can run on many of the available hardware systems in the market today as well as those to come. An integrated system of applications would allow the platform to monitor a variety of patient metrics through wireless technology, Bluetooth being the most common and robust currently, and a series of peripheral sensors and devices which could be individualized to the patient.

In a specific example, the disclosure monitors chronic diseases and conditions such as CHF, DM, COPD/asthma, and medication compliance. This limited list of conditions contributes greatly to the escalating cost of healthcare in the United States. These are not only costly but common conditions.

Careful outpatient monitoring of patients with chronic medical conditions can have a substantial impact on patient care, as well as the cost of care. Currently available hardware, such as iPads, laptop computers, and smart phones with Internet and Bluetooth technology could be united via programming applications with any suitable combination of a variety of peripheral devices to address the outpatient monitoring of chronic disease states and prescribed therapy. For example, the peripheral devices may include scales, glucometers, peak flow meters, sleep apnea mask utilization monitors, blood pressure cuffs, pulse oximeters, webcams, and other suitable peripheral devices in any suitable combination. Furthermore, medication compliance (a substantial and costly barrier to care) could be addressed via a peripheral device to dispense a proper dosage of a required medication at an appropriate time, a monitor for verifying patient compliance for the prescribed medication, and report compliance or non-compliance. Such properly programmed and networked devices would also allow a platform for disease-specific patient education, as well as timely, direct interactive audio and visual evaluation of the patient in their home by a healthcare provider.

The market for such a comprehensive home monitoring system could be individualized to the patient and could be networked to individual physicians, healthcare institutions, insurance companies, and pharmacies. The patient would benefit from potentially improved health and decreased hospitalization, as well as a potentially enhanced understanding of their disease state. The healthcare system as a whole would benefit from decreased healthcare costs. Physicians and hospitals would benefit financially under the evolving system which would reward attainment of disease management metrics. The hospitals would also limit their exposure to unreimbursed services rendered to patients that might have otherwise been re-hospitalized within the designated window for a relapse or exacerbation of their chronic disease state. Private health insurance companies and governmental agencies, such as CMS would see a reduction in claims, realizing a savings in terms of both payments and processing costs. Pharmacies and drug manufactures might be interested in competing for access to these patients and contracting for the maintenance and stocking of their medication dispensers. The data generated by this outpatient monitoring system could be used in drug and medical device studies to the benefit, of patients, industry, and society as a whole. Manufacturers of the high tech computer equipment employed as the hardware platform for the monitoring system would benefit by gaining access to a large segment of the population (the elderly) that do not routinely use such equipment.

Various embodiments of a universal healthcare program are disclosed that can run on many of the available hardware platforms on the market today. An integrated system of application program interfaces (APIs) would allow the platform, in conjunction with the healthcare program, to monitor a variety of patient metrics through a series of peripheral sensors and devices. The system may implement any suitable wireless and/or wired technology for communications between the hardware platform, local peripherals for the platform, networks, and network nodes associated with providing healthcare to the patient. The configuration and arrangement of sensors, medical devices, and computer devices could be individualized and customized to the needs and desires of the patient. Data collected from these peripheral devices (e.g. weight from a scale, peak flow readings from a monitor, glucose levels from a glucometer, or medication compliance based on the use of a computerized pill dispenser) can be stored electronically and can be formatted for easy future analysis by the patient's healthcare provider. The collected data could be interfaced with an electronic medical record. Collected data across a population could serve as a database for scientific studies regarding treatment regimens. The patient information can be electronically transferred on a regular basis to the patient's electronic medical record. Certain parameters could be set as the default or altered by the healthcare provider as sufficiently out of range to trigger contact of the provider automatically. This allows for early detection and treatment of developing problems rather than waiting for a regularly scheduled office visit or the development of frank clinical de-compensation requiring urgent intervention with emergency room visits and/or hospitalization.

Various embodiments of the system allow monitoring of several patient health metrics to allow early medical intervention and decrease re-hospitalization. The platform, in conjunction with the healthcare application, supports multiple interactive health related functions. The healthcare application allows access to a library of pre-recorded educational health-related videos. For example, the patient could access educational information on his specific disease(s) or medications. Another embodiment of the healthcare application allows a patient to receive a notification automatically. For example, a patient could receive notification on his/her 50th birthday that he/she would benefit from a screening colonoscopy. The patient could then access a program explaining: cancer risks and the benefits of screening. An additional video could explain the risks benefits and procedural details of a colonoscopy with conscious sedation. Another embodiment of the healthcare application allows the patient to schedule appointments for the procedure.

The system, in conjunction with the healthcare application, facilitates a more sophisticated version of the nurse phone call follow-up programs that some healthcare and insurance organizations have already started to implement. Across the country, such nurse follow-up programs have proven successful in decreasing the CHF re-hospitalization rate and have proven cost effective. Summa Care is one local organization that has implemented such a program. Akron City Hospital is currently developing a heart failure clinic model. Using the healthcare application, nurses and physicians could perform remote interactive patient evaluations with the benefit of real-time video as well as previously collected health history, monitored metrics, and recent vital signs.

Since the healthcare application is running in the patient's home, the system can allow patients easy access to emergency services similar to the current “Life Alert” system. In other words, an emergency and/or security service can be contacted by the system, in conjunction with the healthcare application, at the touch of a button (or a series of buttons) on a remote control and/or communication device. Similarly, a designated emergency contact can be contacted by the system, in conjunction with the healthcare application, using the remote control and/or communication device. The system, in conjunction with the healthcare application, can also communicate with emergency service, security services, and emergency contacts based on detection of a predetermined events by the physiological and compliance monitoring detection of the patient.

Various embodiments of the system, in conjunction with the healthcare application and peripherals, can be tailored to treatment and monitoring a patient with a specific common costly chronic disease. For example, the chronic diseases and conditions that the system can address include CHF, DM, COPD/asthma, and medication compliance. This exemplary list of conditions contributes greatly to the escalating cost of healthcare in the United States. Clearly new interventions, such as the healthcare application described herein, are required to improve treatment of CHF and reduce the costs associated therewith. The healthcare application can enhance the ability of primary care physicians to deliver the degree of comprehensive diabetes care required to substantially decrease the costs of diabetes associated complications. The system, in conjunction with the healthcare application, can also be employed in the monitoring and treatment of the chronic lung diseases, such as COPD and asthma. The healthcare application can be employed to intervene in a manner that decreases hospitalization rates associated with these common diseases.

While there are many obstacles to patient compliance with prescribed medications, a mechanism by which the proper pill is dispensed at the appropriate time and the patient is signaled would likely enhance compliance. Furthermore, medication compliance could be tracked allowing the healthcare team to more efficiently assess medication effect and research other causes for the patient's failure to comply with the prescribed medical regimen. The healthcare application promotes and tracks medication compliance using an electronic pill dispensing device with compliance monitoring features. The system, in conjunction with the healthcare application, integrates multiple technology elements in a manner that improves patient outcomes and decrease healthcare costs. The healthcare application also advances the current state of the nationwide healthcare delivery system.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace altera60ns, modifications, and variations that fall within the scope of the appended claims. Furthermore, the preceding description is not meant to limit the scope of the invention. Rather, the scope of the invention is to be determined by the appended claims and their equivalents.

As used herein, “connection” or “connected” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or bath”. When the applicants intend to indicate “only A or B but not both” then the term “only A or B but not bath” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modem Legal Usage 624 (2d. Ed. 1995).

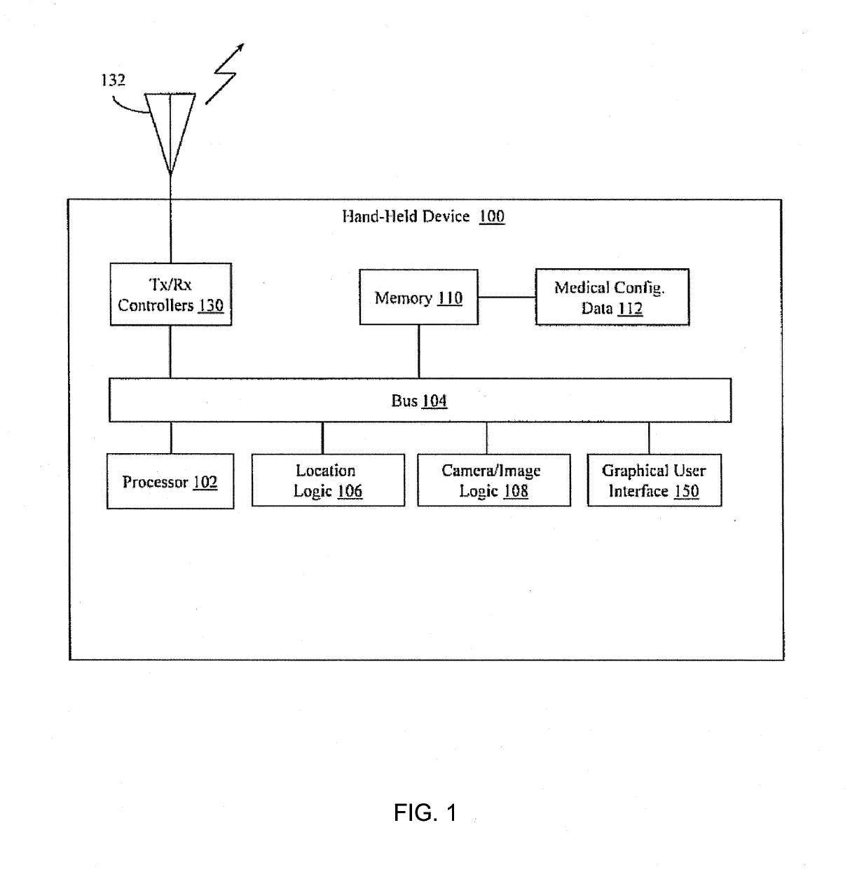

With reference to FIG. 1, an exemplary device 100 is shown. In various embodiments, the device can include various types computer platforms including hand held device, vehicle-mounted device, laptop computer, desktop computer, smart phone, tablet, e-book reader and the like. The device 100 includes a processor 102 capable of executing computer instructions including applications or so-called “apps” that can be installed directly or downloaded. The processor 102 may be in electrical or signal communication with components, for example, over bus 104. The device 100 may include location logic 106 that is capable of estimating location through cell-tower or other triangulation, dead reckoning, GPS, and the like. The device may include image logic 108 that is capable of controlling a camera. Memory 110 may be any conventional, volatile, or non-volatile memory, including internal or removable memory devices. The memory may be further allocated to assign a medical configuration data store 112 for storing medical data sent to or from the app. In certain embodiments, the device may include transmit/receive controllers 130, for wirelessly transmitting report data and/or downloading processor or application updates via antenna 132. Various wireless networks can be accessed including cellular telephony networks, IEEE 802.11 networks, Wi-Fi, Bluetooth, ZigBee and others now in existence or later developed. Alternatively, the device may connect via wire or other data communication network or service. Additionally, the device may be configured to access multiple different types of wireless and/or wire line networks. Device 100 may be controlled by a user through a graphical user interface 150 or other interface, such as a voice recognition interface, a keyboard, or any suitable combination of input devices.

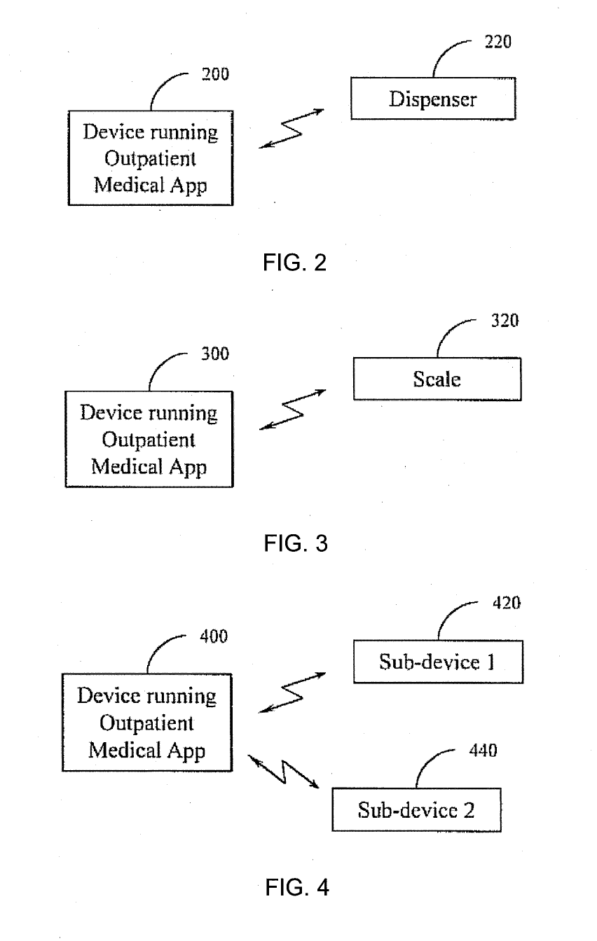

With reference to FIG. 2, device 200 is shown wirelessly connected to a pill dispenser 220, similar to a Model MedSmart Plus (MD2 Plus) by e-pill, LLC of Wellesley, Massachusetts. The wireless interface between the device 200 and the pill dispenser 220 may use Bluetooth technology or any suitable wireless technology. The wireless pill dispenser configuration of the device 200 may reduce the risk of medication non-adherence because the pill dispenser can be remotely controlled to dispense a predetermined pill regimen based on the time of day. The pill dispenser 220 removes the stress of having to remember what pills need to be taken. This configuration also offers peace of mind to loved ones because the device 200 can automatically notify a predetermined person if a dosage was missed.

With reference to FIG. 3, device 300 is shown wirelessly connected to a weight scale 320, such as the Model HD-351 BT digital scale with Bluetooth by Tanita Corporation of Arlington Heights, Ill. The wireless interface between the device 300 and the weight scale 320 may use Bluetooth technology or any suitable wireless technology. The wireless weight scale configuration of the device 300 may allow the patient and the doctor to understand weight trends overtime. This will help physicians propose weight goals to the patient while also allowing the patient to gain a visual knowledge of their weight fluctuations.

With reference to FIG. 4, device 400 is shown wirelessly connected to a condition monitor 420, such as the Model FORA D15b blood glucose plus blood pressure monitoring system with Bluetooth by Fora Care, Inc. of Newbury Park, Calif. The wireless interface between the device 400 and the condition monitor 420 may use Bluetooth technology or any suitable wireless technology. The wireless condition monitor configuration of the device 400 may allow a historical record of blood glucose and blood pressure measurements to be made. The monitoring of other patient conditions may of course be added or substituted in the condition monitor 420, such as a heart rate monitor, a sleep cycle monitor, a temperature monitor, and the like.

In addition to record keeping, the device 200, 300, 400 may also be configured to alert physician, nurse or family member upon a defined event such as non-compliance or upon the user selecting an “Alert” option for other emergencies.

Various embodiments of a medical condition monitoring system and methods associated therewith are disclosed herein. In one embodiment, the system includes a condition monitor configured to monitor a patient condition and a communication device. For example, the communication device may include at least one communication interface, a memory device, a processor, and a display device. One communication interface is in selective communication with the condition monitor. The memory device is configured to store a medical management application. The medical management application is configured to assemble information related to a medical event including data from the condition monitor, prepare a report based on the medical event, and make the medical report accessible for retrieval by a separate device. The processor is configured to execute the medical management application. The display device is configured to display a graphical user interface associated with the medical management application when the medical management application is executed by the processor. The handheld electronic device is configured to make the medical report accessible for retrieval by the separate device when a communication link is established between the separate device and the communication device.

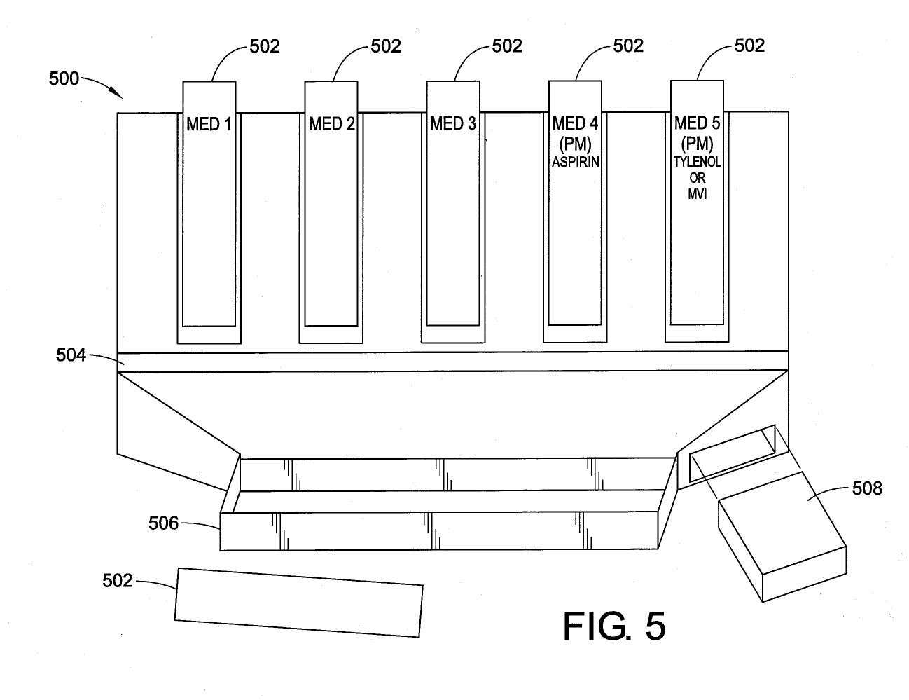

With reference to FIG. 5, an exemplary embodiment of a medication dispensing system 500 includes a plurality of medication cartridges 502, an activation system 504, a collection tray 506, and a travel unit 508.

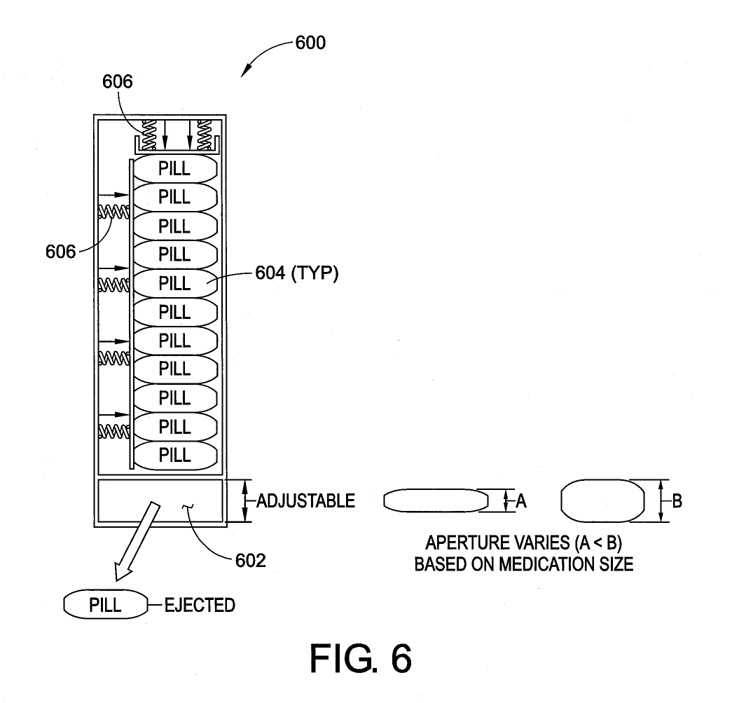

With reference to FIG. 6, an exemplary embodiment of a medication cartridge 600 for a medication dispensing system 500 includes an aperture 602 through which one or more pills 604 can be ejected by a mechanism 606 that advances or pushes the next pill 604 to the aperture 602 and ejects it for delivery to an output (not shown) via a dispensing path (not shown). The mechanism 606 may include springs that resiliently bias an inventory of pills toward the aperture 602. Activation of an actuator (not shown) associated with the medication dispensing system 500 is mechanically linked to the mechanism 606 in a manner that leads to ejection of a desired dosage of pills 604.

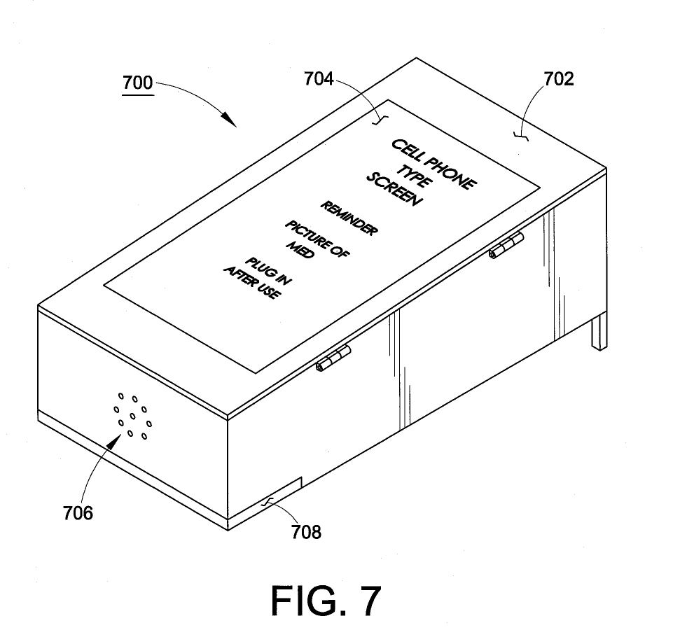

With reference to FIG. 7, an exemplary embodiment of a travel box 700 for a medication dispensing system 500 that holds a complement of pills 602 dispensed for a patient in conjunction with a specified travel time. The travel box 700 includes a hinged lid 702, a display screen 704, an alarm device 706, a controller (not shown), and a battery assembly 708.

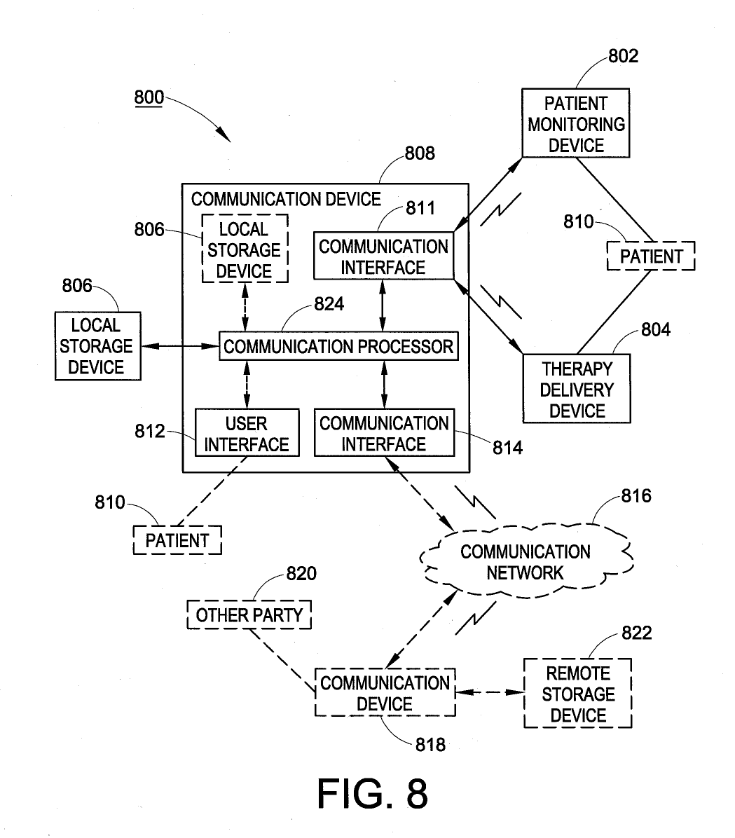

With reference to FIG. 8, an exemplary embodiment of a home healthcare system 800 includes a patient monitoring device 802, a therapy delivery device 804, a local storage device 806, and a communication device 808. The patient monitoring device 802 is configured to monitor a physiological condition of a patient 810 in a home or home-like environment. The home includes premises in which the patient 810 has established legal residency. The home-like environment includes other types of premises that provide more temporary living quarters to the patient 810, such as the home of a relative, friend, or another person, a nursing home, an assisted-living facility, a group home, a dormitory room, a mobile home, a recreational vehicle, a disciplinary or correctional facility, and other types of premises that provide suitable living quarters to the patient.

The therapy delivery device 804 is configured to hold an inventory of a prescribed therapy for medical treatment of the patient 810 in the home or home-like environment. The prescribed therapy may include a prescription drug, an over-the-counter (OTC) medication, a healthcare supplement, a vitamin, a dietary supplement, or any suitable medication or therapy prescribed by an authorized healthcare provider for medical treatment of the patient. The therapy delivery device 804 is also configured to selectively deliver a prescribed dosage of the prescribed therapy to the patient 810. The local storage device 806 is configured to at least temporarily store information associated with the physiological condition of the patient 810, information associated with the prescribed therapy for the patient 810, and information associated with the medical treatment of the patient 810. The local storage device 806 may be external to the communication device 808 (as shown in solid lines) or internal (as shown in dashed lines). The therapy delivery device 804 may hold a plurality of prescribed therapies for medical treatment of the patient. The dispensing of each prescribed therapy to the patient may be independently controlled in the same manner described herein for an exemplary prescribed therapy.

The communication device 808 is in operative communication with the patient monitoring device 802, therapy delivery device 804, and local storage device 806. The communication device 808 may include a communication interface 811 that supports wired and/or wireless communications with the patient monitoring device 802 and/or therapy delivery device 804. The communication device 808 is configured to provide a user interface 812 to the patient 810 in conjunction with utilization of the patient monitoring device 802 and therapy delivery device 804. The communication device 808 is also configured to provide a communication interface 814 with a communication network 816 outside the home or home-like environment to enable establishment of a communication session to/from another communication device 818 associated with another party 820. The communication interface 814 also supports communication sessions to/from a remote storage device 822 via the communication network 816. A communication processor 824 that effectively controls operation of the components within the communication device 808 and coordination of operations involving other devices.

In another embodiment of the home healthcare system 800, the communication device 808 is configured to control the user interface 812 and the patient monitoring device 802 to selectively obtain measurements of the physiological condition of the patient 810 and to at least temporarily store the physiological measurements in the local storage device 806. In the further embodiment of the home healthcare system 800, the communication device 808 is configured to process the physiological measurements and to perform at least one of 1) identify an alert condition regarding the physiological condition of the patient 810 that requires notification of the patient 810 and provide an alert indication to the patient 810 via the user interface 812 after identification of the alert condition, 2) identify an urgent condition regarding the physiological condition of the patient 810 that requires notification of another party 820 and initiate an urgent communication session to the other party 820 via the communication network 816 after identification of the urgent condition, and 3) periodically send physiological measurements to an authorized party 820, 822 via the communication network 816.

In yet another embodiment of the home healthcare system 800, the patient monitoring device 802 may include a weight scale, a thermometer, a blood pressure meter, a heart rate monitor, an EKG device, a glucose meter, a peak flow meter, a pulse oximeter, a distance measuring device, a camera, or any suitable monitoring device in any suitable combination.

In still another embodiment of the home healthcare system 800, the communication device 808 is configured to control the user interface 812 and the therapy delivery device 804 to deliver the prescribed dosage to the patient 810 in accordance with a predetermined schedule. In this embodiment, the communication device 808 is also configured to obtain compliance information from the therapy delivery device 804 indicative of patient compliance or non-compliance with the prescribed therapy. In the embodiment being described, the communication device 808 is also configured to at least temporarily store the compliance information in the local storage device 806. In a further embodiment of the home healthcare system 800, the communication device 808 is configured to process the compliance information and to perform at least one of 1) identify an alert condition regarding non-compliance with the prescribed therapy that requires notification of the patient 810 and provide an alert indication to the patient 810 via the user interface 812 after identification of the alert condition, 2) identify an urgent condition regarding non-compliance with the prescribed therapy that requires notification of another party 820 and initiate an urgent communication session to the other party 820 via the communication network 816 after identification of the urgent condition, and 3) periodically send compliance information indicative of patient compliance or non-compliance with the prescribed therapy to an authorized party 820, 822 via the communication network 816.

In yet another embodiment of the home healthcare system 800, the communication device 808 is configured to obtain inventory information from the therapy delivery device 804 regarding the inventory of the prescribed therapy. In this embodiment, the communication device 808 is also configured to at least temporarily store the inventory information in the local storage device 806. In a further embodiment of the home healthcare system 800, the communication device 808 is configured to process the inventory information and to perform at least one of 1) identify an alert condition regarding the inventory of the prescribed therapy that requires notification of the patient 810 and provide an alert indication to the patient 810 via the user interface 812 after identification of the alert condition, 2) identify an urgent condition regarding the inventory of the prescribed therapy that requires notification of another party 820 and initiate an urgent communication session to the other party 820 via the communication network 816 after identification of the urgent condition, and 3) periodically send inventory information regarding the inventory of the prescribed therapy to an authorized party 820, 822 via the communication network 816.

In still yet another embodiment of the home healthcare system 800, the therapy delivery device 804 may include a pill dispenser for delivering a prescribed dosage of a pill therapy to the patient 810, a liquid dispenser for delivering a prescribed dosage of a liquid therapy to the patient 810, a lotion dispenser for delivering a lotion therapy to the patient 810, a time-release patch dispenser for delivering a patch therapy to the patient 810, or any suitable delivery device in any suitable combination.

In still yet another embodiment of the home healthcare system 800, the communication device 808 and at least one of the patient monitoring device 802 and the therapy delivery device 804 include a short range wireless interface 811 and the corresponding devices are configured to communication via short range wireless communications. In a further embodiment of the home healthcare system 800, the short range wireless interfaces are configured for Bluetooth communications, infrared communications, or any suitable short range wireless communication technology in any suitable combination.

In another embodiment of the home healthcare system 800, the communication device 808 is configured to receive a request for establishment of a communication session from an authorized party 820 via the communication network 816. In this embodiment, the communication device 808 is also configured to control the user interface 812 in order to notify the patient 810 of the request. In the embodiment being described, the communication device 808 is also configured to enable communication with the authorized party 820 in response to activation of a connect control associated with the user interface 812 after establishment of the communication session.

In yet another embodiment of the home healthcare system 800, the communication device 808 is configured to control the user interface 812 to permit the patient 810 to initiate a request for establishment of a communication session with an authorized party 820 via the communication network 816. In this embodiment, the communication device 808 is also configured to enable communication with the authorized party 820 after establishment of the communication session.

In still another embodiment of the home healthcare system 800, the communication device 808 is configured to receive a communication session from an authorized party 820 via the communication network 816, parse content of the communication session, identify an update to the prescribed therapy based at least in part on the parsed content, and update the information associated with the prescribed therapy stored in the local storage device 806 based at least in part on the content of the communication session.

In still yet another embodiment of the home healthcare system 800, the communication device 808 is configured to construct content for a communication session based at least in part on at least one of information associated with the physiological condition of the patient 810, information associated with the prescribed therapy for the patient 810, and information associated with the medical treatment of the patient 810 in conjunction with at least one of utilization of the patient monitoring device 802 and utilization of the therapy delivery device 804. In this embodiment, the communication device 808 is also configured to send the communication session with the constructed content to an authorized party 820, 822 via the communication network 816.

In another embodiment of the home healthcare system 800, the user interface 812 includes a video camera. In this embodiment, the communication device 808, user interface 812, and communication interface 814 are configured to permit interactive audio and video communication between the patient 810 and a healthcare provider 820 associated with medical treatment of the patient 810 via the communication network 816.

In yet another embodiment of the home healthcare system 800, the communication device 808 includes a cellular telephone, a smart telephone, a tablet computer, an e-book device, a personal digital assistant, a handheld computer, a laptop computer, a desktop computer, a video telephone, a satellite telephone, a landline telephone, or any suitable communication device in any suitable combination.

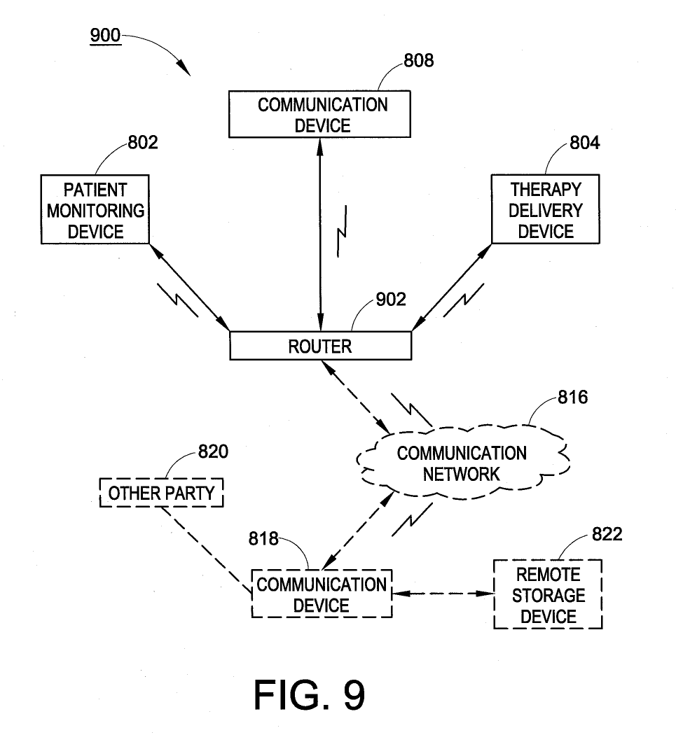

With reference to FIG. 9, an exemplary embodiment of a home healthcare system 900 includes a router 902 and the patient monitoring device 802, therapy delivery device 804, and communication device 808 of the home healthcare system 800 of FIG. 8. The router 902 is configured to form a local area network interconnecting the communication device 808, patient monitoring device 802, and therapy delivery device 804. The router 902 is also configured to provide access to the communication network 816 outside the home or home-like environment in the same manner as described above for the home healthcare system 800 of FIG. 8. In another exemplary embodiment of the home healthcare system 900, the router 902, communication device 808, patient monitoring device 802, and therapy delivery device 804 include short range wireless interfaces and the corresponding devices are configured to communication via short range wireless communications. In a further embodiment of the home healthcare system 900, the short range wireless interfaces are configured for WiFi communications, infrared communications, or any suitable short range wireless communication technology in any suitable combination.

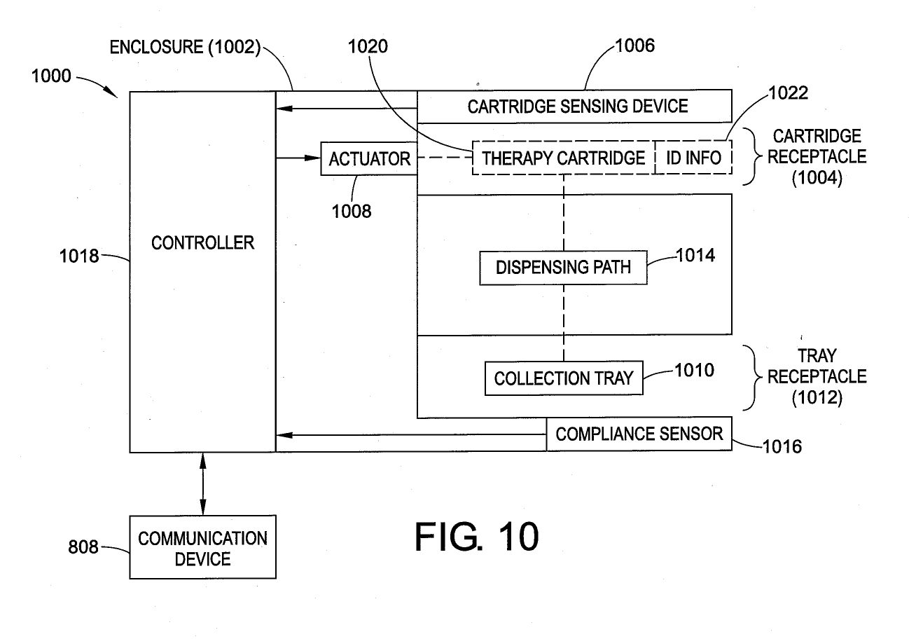

With reference to FIG. 10, an exemplary embodiment of a therapy delivery device 1000 for a home healthcare system (e.g., 800, 900) includes an enclosure 1002 including at least one cartridge receptacle 1004, a cartridge sensing device 1006 for each cartridge receptacle 1004, an actuator 1008 for each cartridge receptacle 1004, a collection tray 1010 disposed in a tray receptacle 1012, a dispensing path 1014, a compliance sensor 1016, and a controller 1018. Each cartridge receptacle 1004 configured to receive a therapy cartridge 1020. Each therapy cartridge 1020 configured to hold a quantity of some therapy for medical treatment of some patient 810. Each therapy cartridge 1020 including identifying information 1022. Each cartridge sensing device 1006 configured to detect the identifying information 1022 associated with a corresponding therapy cartridge 1020 received by the cartridge receptacle 1004.

Each actuator 1008 configured to control the therapy cartridge 1020 received by the corresponding cartridge receptacle 1004 to release the prescribed dosage of the prescribed therapy. The collection tray 1010 configured to collect the prescribed dosage of the prescribed therapy for delivery to the patient 810. The dispensing path 1014 being in fluidic communication with the at least one cartridge receptacle 1004 and collection tray 1010. The dispensing path 1014 is configured to direct the prescribed dosage of the prescribed therapy from the corresponding cartridge receptacle 1004 to the collection tray 1010 after release of the prescribed therapy from the therapy cartridge 1020. The compliance sensor 1016 is disposed in relation to the collection tray 1010 to detect compliance information indicative of patient compliance or non-compliance with the prescribed therapy in conjunction with the prescribed dosage. The controller 1018 is in operative communication with the cartridge sensing device 1006, actuator 1008, compliance sensor 1016, and communication device 808. The controller 1018 is configured to operate in a coordinated manner with the communication device 808 such that the inventory of the prescribed therapy for medical treatment of the patient 810 is held and the prescribed dosage is properly delivered to the patient 810.

In another embodiment of the therapy delivery device 1000, the identifying information 1022 associated with each therapy cartridge 1020 includes at least one of 1) the prescribed therapy held by the cartridge 1020, 2) the patient 810 for which the therapy is prescribed, and 3) the quantity of the therapy originally held by the cartridge 1020.

In yet another embodiment of the therapy delivery device 1000, the compliance sensor 1016 is configured to detect at least one of 1) removal of the collection tray 1010 from the therapy delivery device 1000 after the prescribed dosage of the prescribed therapy is dispensed, 2) return of the collection tray 1010 to the therapy delivery device 1000 after removal of the collection tray 1010, 3) verification that the prescribed dosage dispensed into the collection tray 1010 is no longer present, and 4) activation of an acknowledgement control (not shown) that the prescribed dosage delivered by the therapy delivery device 1000 was taken by the patient 810.

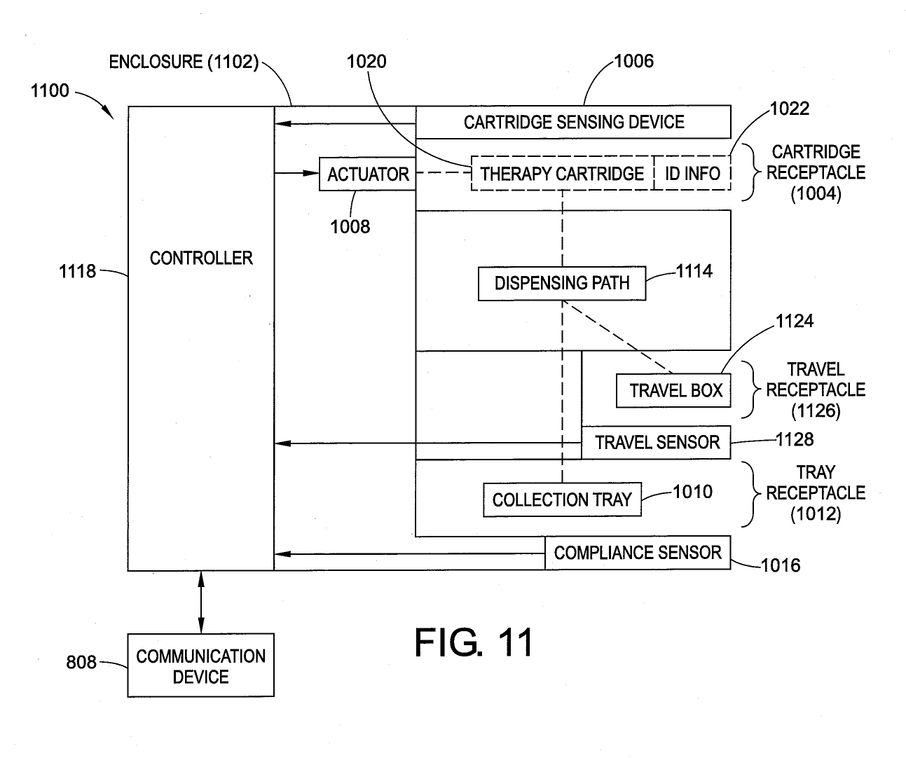

With reference to FIG. 11, another exemplary embodiment of a therapy delivery device 1100 for a home healthcare system (e.g., 800, 900) includes the at least one cartridge receptacle 1004, a cartridge sensing device 1006 for each cartridge receptacle 1004, actuator 1008 for each cartridge receptacle 1004, collection tray 1010 disposed in the tray receptacle 1012, and compliance sensor 1016 of the therapy delivery device 1000 of FIG. 10. The therapy delivery device 1100 also includes an enclosure 1102, a dispensing path 1114, and a controller 1118 similar to like components of the therapy delivery device 1000 of FIG. 10. The therapy delivery device 1100 also includes a travel box 1124 disposed in a travel receptacle 1126 and a travel sensor 1128. The travel box 1124 is configured to collect one or more prescribed dosages of the prescribed therapy over a patient-specified travel time for delivery to the patient 810. The travel sensor 1128 is in operative communication with the controller 1118 and disposed in relation to the travel box 1124 to detect compliance information indicative of patient compliance or non-compliance with the one or more prescribed dosages. The dispensing path 1114 is adjustable for directing the prescribed therapy from the corresponding cartridge receptacle 1004 to the collection tray 1010 or the travel box 1124. The user interface 812 is configured to allow the patient 810 to specify the travel time and request delivery of the prescribed therapy to the travel box 1124. The communication device 808 is configured to control the therapy delivery device 1100 to dispense the one or more prescribed dosages of the prescribed therapy to the travel box 1124.

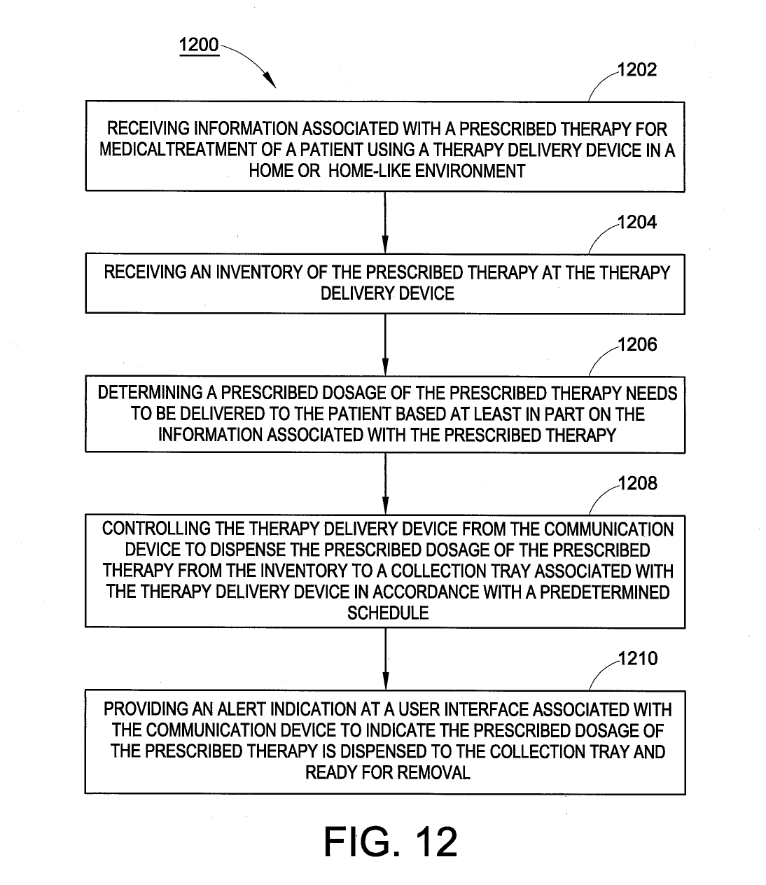

With reference to FIG. 12, an exemplary embodiment of a process 1200 for enhancing home healthcare begins at 1202 where information that is associated with a prescribed therapy for medical treatment of a patient using a therapy delivery device in a home or home-like environment is received. The information associated with the prescribed therapy is received at a communication device and at least temporarily stored in a local storage device. At 1204, an inventory of the prescribed therapy is received at the therapy delivery device. The therapy delivery device is configured to hold the inventory and to selectively deliver a prescribed dosage of the prescribed therapy to the patient. Next, the process determines a prescribed dosage of the prescribed therapy needs to be delivered to the patient based at least in part on the information associated with the prescribed therapy (1206). At 1208, the therapy delivery device is controlled by the communication device to dispense the prescribed dosage of the prescribed therapy from the inventory to a collection tray associated with the therapy delivery device in accordance with a predetermined schedule. Next, an alert indication is provided at a user interface associated with the communication device to indicate the prescribed dosage of the prescribed therapy is dispensed to the collection tray and ready for removal (1210).

In another embodiment of the process 1200, the information associated with the prescribed therapy is received by the communication device from an authorized party via the user interface. In still another embodiment of the process 1200, the communication device is configured to provide a communication interface with a communication network outside the home or home-like environment to enable establishment of a communication session to/from another communication device associated with another party. In a further embodiment of the process 1200, the information associated with the prescribed therapy is received by the communication device via the communication network in a communication session from a healthcare provider associated with medical treatment of the patient.

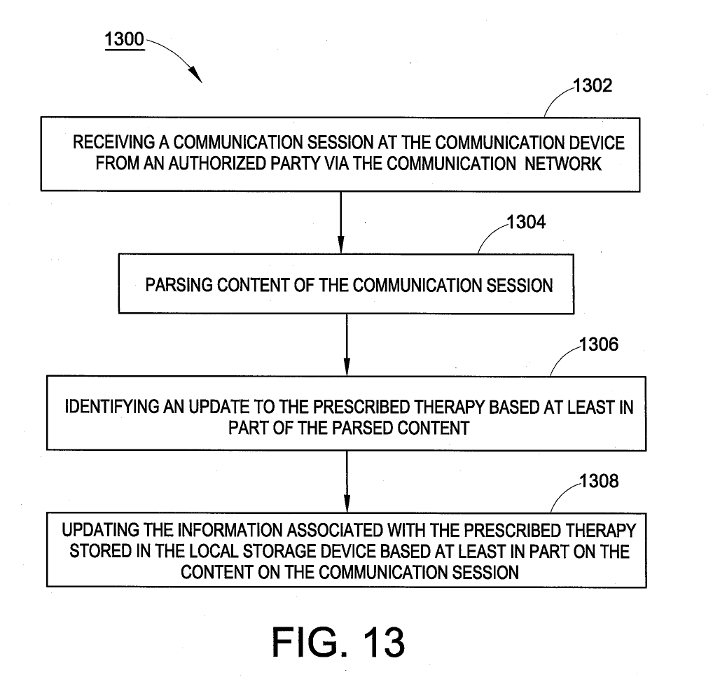

With reference to FIGS. 13 and 12, another exemplary embodiment of a process 1300 for enhancing home healthcare extends the process 1200 of FIG. 12. In this embodiment, the communication device is configured to provide a communication interface with a communication network outside the home or home-like environment to enable establishment of a communication session to/from another communication device associated with another party. At 1302, a communication session is received at the communication device from an authorized party via the communication network. Next, content of the communication session is parsed (1304). At 1306, an update to the prescribed therapy is identified based at least in part on the parsed content. Next, the information associated with the prescribed therapy stored in the local storage device is updated based at least in part on the content of the communication session (1308). The process 1200 of FIG. 12 can use the updated information in conjunction with delivering the prescribed dosage of the prescribed therapy to the patient.

With reference again to FIG. 12, another exemplary embodiment of the process 1200 also includes obtaining compliance information from the therapy delivery device at the communication device. The compliance information is indicative of patient compliance or non-compliance with the prescribed therapy. Next, the compliance information is at least temporarily stored in the local storage device. In a further embodiment, the process 1200 may also include processing the compliance information. In this embodiment, an alert condition regarding non-compliance with the prescribed therapy that requires notification of the patient may be identified. An alert indication may be provided to the patient via the user interface after identification of the alert condition. In another further embodiment, the process 1200 may also include processing the compliance information. In this embodiment, an urgent condition regarding non-compliance with the prescribed therapy that requires notification of another party may be identified. An urgent communication session to the other party via the communication network may be initiated after identification of the urgent condition. In yet another further embodiment, the process 1200 may also include periodically sending compliance information indicative of patient compliance or non-compliance with the prescribed therapy to an authorized party via the communication network.

In yet another exemplary embodiment, the process 1200 may also include obtaining inventory information from the therapy delivery device regarding the inventory of the prescribed therapy. Next, the inventory information is at least temporarily stored in the local storage device. In a further embodiment, the process 1200 may also include processing the inventory information. In this embodiment, an alert condition regarding the inventory of the prescribed therapy that requires notification of the patient may be identified. An alert indication may be provided to the patient via the user interface after identification of the alert condition. In another further embodiment, the process 1200 may also include processing the inventory information. In this embodiment, an urgent condition regarding the inventory of the prescribed therapy that requires notification of another party may be identified. An urgent communication session to the other party via the communication network may be initiated after identification of the urgent condition. In yet another further embodiment, the process 1200 may also include periodically sending inventory information regarding the inventory of the prescribed therapy to an authorized party via the communication network.

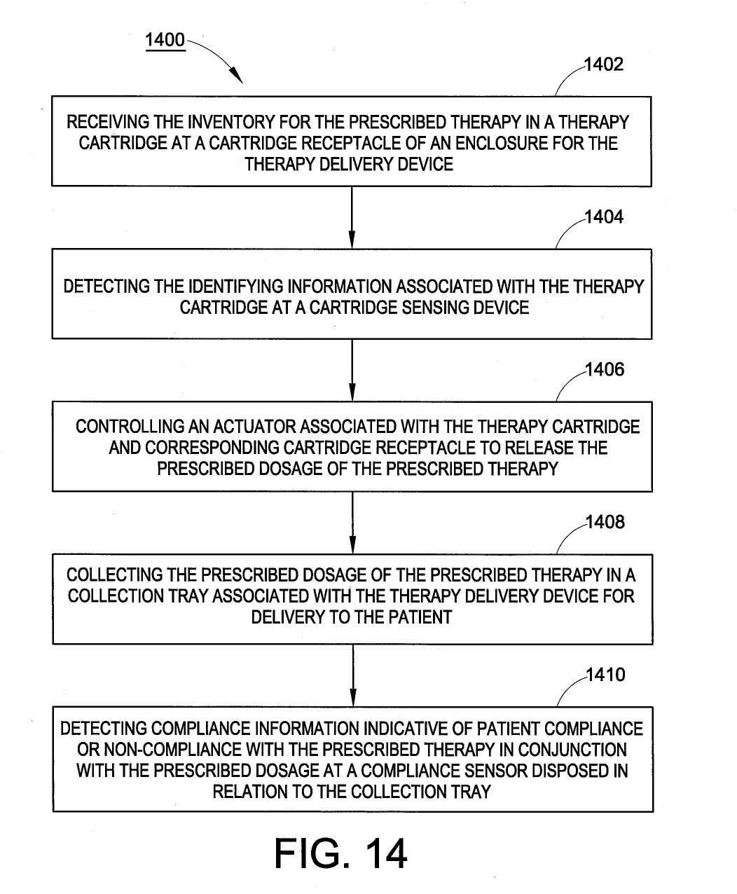

With reference to FIGS. 14 and 12, yet another exemplary embodiment of a process 1400 for enhancing home healthcare extends the process 1200 of FIG. 12. At 1402, the inventory for the prescribed therapy is received in a therapy cartridge at a cartridge receptacle of an enclosure for the therapy delivery device. The enclosure including at least one cartridge receptacle. The therapy cartridge configured to hold a quantity of the prescribed therapy for medical treatment of the patient. Each therapy cartridge including identifying information. At 1404, the identifying information associated with the therapy cartridge is detected at a cartridge sensing device. Next, an actuator associated with the therapy cartridge and corresponding cartridge receptacle is controlled to release the prescribed dosage of the prescribed therapy (1406). At 1408, the prescribed dosage of the prescribed therapy is collected in a collection tray associated with the therapy delivery device for delivery to the patient. A dispensing path in fluidic communication with the cartridge receptacle and collection tray is configured to direct the prescribed dosage of the prescribed therapy from the corresponding cartridge receptacle to the collection tray after release of the prescribed therapy from the therapy cartridge. Next, compliance information indicative of patient compliance or non-compliance with the prescribed therapy in conjunction with the prescribed dosage is detected at a compliance sensor disposed in relation to the collection tray (1410).

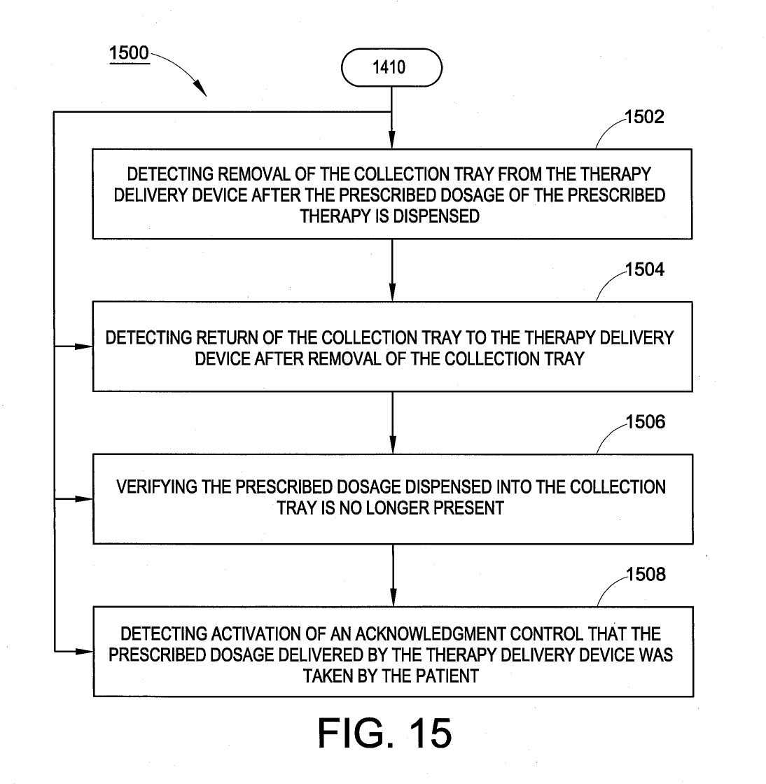

With reference to FIGS. 15, 12, and 14, still another exemplary embodiment of a process 1500 for enhancing home healthcare extends the process 1400 of FIG. 14 as well as the process 1200 of FIG. 12. In this embodiment, the detecting of the compliance information in 1410 includes at least one of further components 1502, 1504, 1506, and 1508: At 1502, the process 1500 includes detecting removal of the collection tray from the therapy delivery device after the prescribed dosage of the prescribed therapy is dispensed. At 1504, the process 1500 includes detecting return of the collection tray to the therapy delivery device after removal of the collection tray. At 1506, the process 1500 includes verifying the prescribed dosage dispensed into the collection tray is no longer present. At 1508, the process 1500 includes detecting activation of an acknowledgement control that the prescribed dosage delivered by the therapy delivery device was taken by the patient.

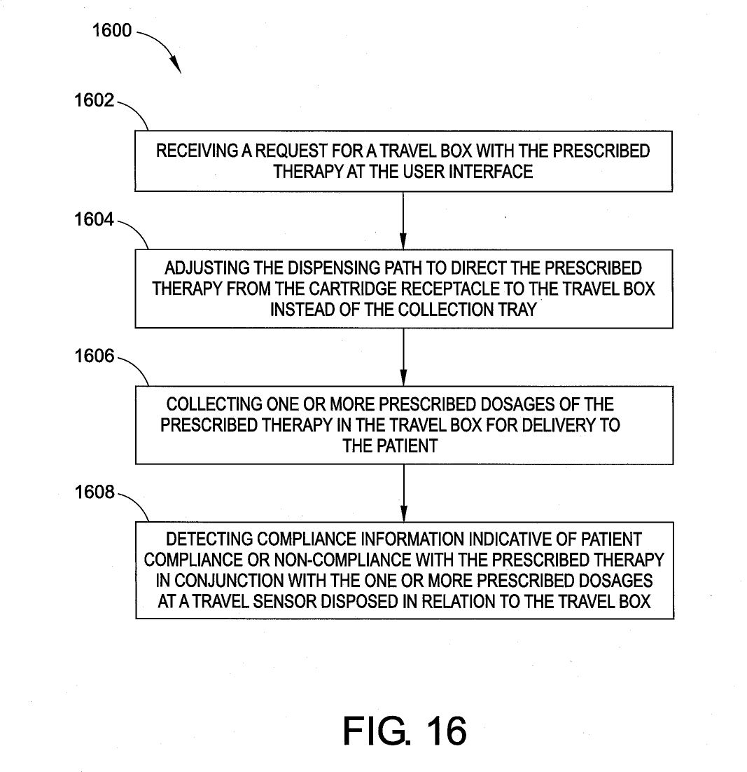

With reference to FIGS. 16, 12, and 14, still yet another exemplary embodiment of a process 1600 for enhancing home healthcare extends the process 1400 of FIG. 14 as well as the process 1200 of FIG. 12. At 1602, a request for a travel box with the prescribed therapy is received at the user interface. The request includes a travel time over which the travel box is expected to be used. The travel box is associated with the therapy delivery device. Next, the dispensing path is adjusted to direct the prescribed therapy from the cartridge receptacle to the travel box instead of the collection tray (1604). At 1606, one or more prescribed dosages of the prescribed therapy is collected in the travel box for delivery to the patient. The amount of prescribed dosages is based at least in part on the travel time. Next, compliance information indicative of patient compliance or non-compliance with the prescribed therapy in conjunction with the one or more prescribed dosages is detected at a travel sensor disposed in relation to the travel box (1608).

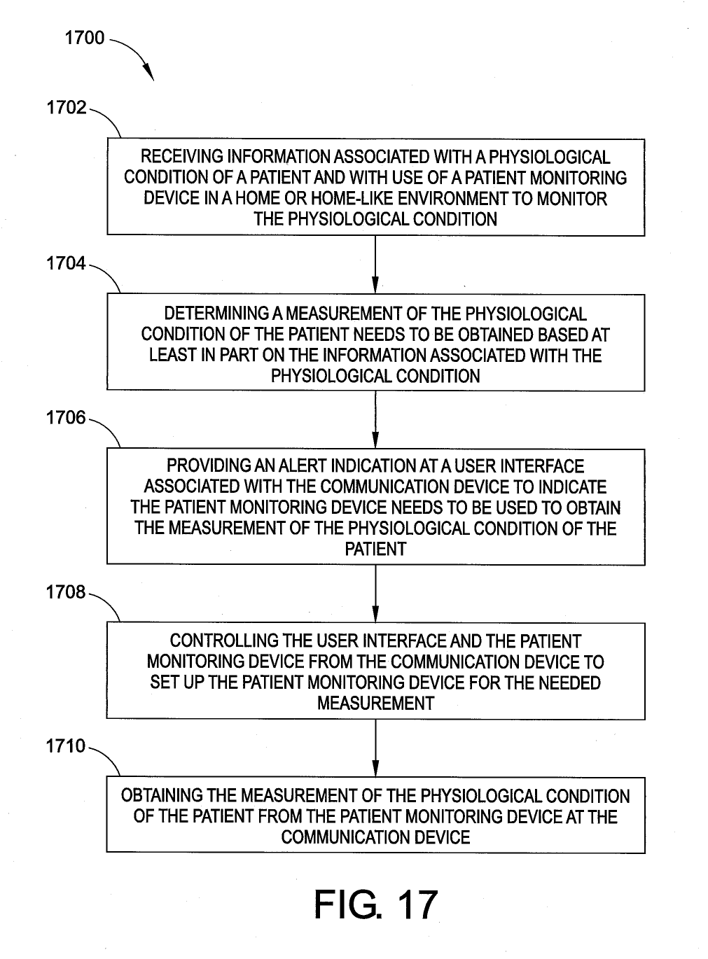

With reference to FIG. 17, an exemplary embodiment of a process 1700 for enhancing home healthcare begins at 1702 where information associated with a physiological condition of a patient and with use of a patient monitoring device in a home or home-like environment to monitor the physiological condition is received. The information is received at a communication device and at least temporarily stored in a local storage device. At 1704, the process determines a measurement of the physiological condition of the patient needs to be obtained based at least in part on the information associated with the physiological condition. Next, an alert indication is provided at a user interface associated with the communication device to indicate the patient monitoring device needs to be used to obtain the measurement of the physiological condition of the patient (1706). At 1708, the user interface and the patient monitoring device are controlled by the communication device to set up the patient monitoring device for the needed measurement. Next, the measurement of the physiological condition of the patent is obtained from the patient monitoring device at the communication device.

In another embodiment of the process 1700, the information associated with the physiological condition is received by the communication device from an authorized party via the user interface. In yet another embodiment of the process 1700, the communication device is configured to provide a communication interface with a communication network outside the home or home-like environment to enable establishment of a communication session to/from another communication device associated with another party. In still another embodiment of the process 1700, the information associated with the physiological condition is received by the communication device via the communication network in a communication session from a healthcare provider associated with medical treatment of the patient.

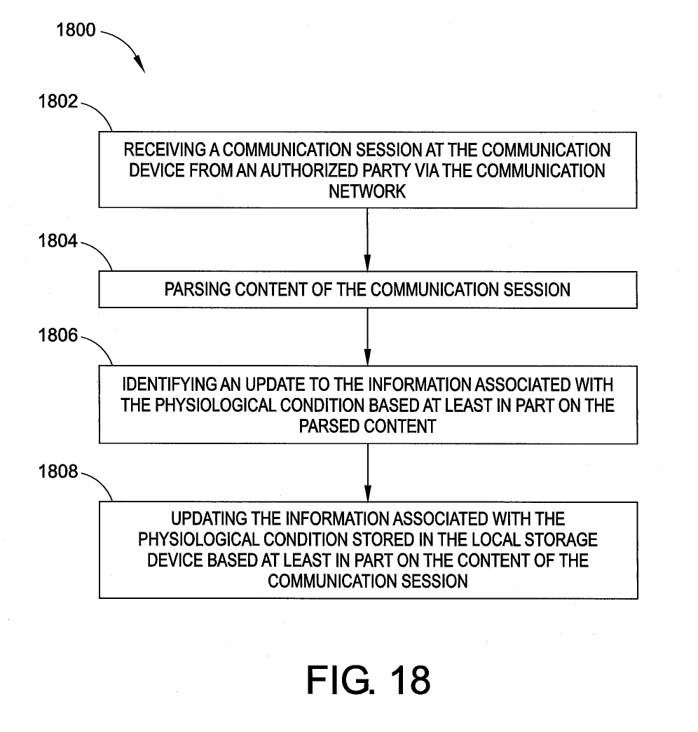

With reference to FIGS. 18 and 17, another exemplary embodiment of a process for enhancing home healthcare extends the process 1700 of FIG. 17. In this embodiment, the communication device is configured to provide a communication interface with a communication network outside the home or home-like environment to enable establishment of a communication session to/from another communication device associated with another party. At 1802, a communication session is received at the communication device from an authorized party via the communication network. Next, content of the communication session is parsed (1804). At 1806, an update to the information associated with the physiological condition is identified based at least in part on the parsed content. Next, the information associated with the physiological condition stored in the local storage device is updated based at least in part on the content of the communication session. The process 1700 of FIG. 17 can use the updated information in conjunction with monitoring the physiological condition of the. patient.

With reference again to FIG. 17, another exemplary embodiment of the process 1700 also includes controlling the user interface and the patient monitoring device from the communication device to selectively obtain measurements of the physiological condition of the patient from the patient monitoring device at the communication device. Next, the physiological measurements are at least temporarily stored in the local storage device. In a further embodiment, the process 1700 also includes processing the physiological measurements. In this embodiment, an alert condition regarding the physiological condition of the patient that requires notification of the patient may be identified. An alert indication may be provided to the patient via the user interface after identification of the alert condition. In another further embodiment, the process 1700 also includes processing the physiological measurements. In this embodiment, an urgent condition regarding the physiological condition of the patient that requires notification of another party may be identified. An urgent communication session to the other party via the communication network may be initiated after identification of the urgent condition. In yet another further embodiment, the process 1700 also includes periodically sending physiological measurements to an authorized party via the communication network.

In various additional embodiments, program instructions stored in a non-transitory computer-readable medium, when executed by a processor, may cause a home healthcare system to perform various combinations of functions associated with the processes 1200 through 1800 for enhancing home healthcare described above in reference to FIGS. 12-18. In other words, the various features described above may be implemented in any suitable combination by the program instructions stored in the non-transitory computer-readable medium. Any suitable components of the home health care system 800, 900, patient monitoring device 802, therapy delivery device 804, 1000, 1100, and communication device 808 described above may include the corresponding processor and non-transitory computer-readable medium associated with the corresponding program instructions. Alternatively, the corresponding processor and non-transitory computer-readable medium associated with the corresponding program instructions may be individual or combined components that are in operative communication with any suitable combination of components of the systems and devices described above.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. An apparatus for enhancing home healthcare, comprising:
a patient monitoring device configured to monitor a physiological condition of a patient in a home or home-like environment;
a therapy delivery device configured to hold an inventory of a prescribed therapy for medical treatment of the patient in the home or home-like environment and to selectively deliver a prescribed dosage of the prescribed therapy to the patient;
a local storage device configured to at least temporarily store information associated with the physiological condition of the patient, information associated with the prescribed therapy for the patient, and information associated with the medical treatment of the patient; and
a communication device in operative communication with the patient monitoring device, therapy delivery device, and local storage device and configured to provide a user interface to the patient in conjunction with utilization of the patient monitoring device and therapy delivery device, wherein the communication device is also configured to provide a communication interface with a communication network outside the home or home-like environment to enable establishment of a communication session to/from another communication device associated with another party.

2. The apparatus of claim 1 wherein the communication device is configured to control the user interface and the patient monitoring device to selectively obtain measurements of the physiological condition of the patient and to at least temporarily store the physiological measurements in the local storage device.

3. The apparatus of claim 2 wherein the communication device is configured to process the physiological measurements and to perform at least one of 1) identify an alert condition regarding the physiological condition of the patient that requires notification of the patient and provide an alert indication to the patient via the user interface after identification of the alert condition, 2) identify an urgent condition regarding the physiological condition of the patient that requires notification of another party and initiate an urgent communication session to the other party via the communication network after identification of the urgent condition, and 3) periodically send physiological measurements to an authorized party via the communication network.

4. The apparatus of claim 1, the patient monitoring device including at least one of a weight scale, a thermometer, a blood pressure meter, a heart rate monitor, an EKG device, a glucose meter, a peak flow meter, a pulse oximeter, a distance measuring device, and a camera.

5. The apparatus of claim 1 wherein the communication device is configured to control the user interface and the therapy delivery device to deliver the prescribed dosage to the patient in accordance with a predetermined schedule, to obtain compliance information from the therapy delivery device indicative of patient compliance or non-compliance with the prescribed therapy, and to at least temporarily store the compliance information in the local storage device.

6. The apparatus of claim 5 wherein the communication device is configured to process the compliance information and to perform at least one of 1) identify an alert condition regarding non-compliance with the prescribed therapy that requires notification of the patient and provide an alert indication to the patient via the user interface after identification of the alert condition, 2) identify an urgent condition regarding non-compliance with the prescribed therapy that requires notification of another party and initiate an urgent communication session to the other party via the communication network after identification of the urgent condition, and 3) periodically send compliance information indicative of patient compliance or non-compliance with the prescribed therapy to an authorized party via the communication network.

7. The apparatus of claim 1 wherein the communication device is configured to obtain inventory information from the therapy delivery device regarding the inventory of the prescribed therapy and to at least temporarily store the inventory information in the local storage device.

8. The apparatus of claim 7 wherein the communication device is configured to process the inventory information and to perform at least one of 1) identify an alert condition regarding the inventory of the prescribed therapy that requires notification of the patient and provide an alert indication to the patient via the user interface after identification of the alert condition, 2) identify an urgent condition regarding the inventory of the prescribed therapy that requires notification of another party and initiate an urgent communication session to the other party via the communication network after identification of the urgent condition, and 3) periodically send inventory information regarding the inventory of the prescribed therapy to an authorized party via the communication network.

9. The apparatus of claim 1, the therapy delivery device including at least one of a pill dispenser for delivering a prescribed dosage of a pill therapy to the patient, a liquid dispenser for delivering a prescribed dosage of a liquid therapy to the patient, a lotion dispenser for delivering a lotion therapy to the patient, and a time-release patch dispenser for delivering a patch therapy to the patient.

10. The apparatus of claim 1 wherein the communication device and at least one of the patient monitoring device and the therapy delivery device include a short range wireless interface and the corresponding devices are configured to communication via short range wireless communications.

11. The apparatus of claim 1, the user interface including a video camera, wherein communication device, user interface, and communication interface are configured to permit interactive audio and video communication between the patient and a healthcare provider associated with medical treatment of the patient via the communication network.

12. The apparatus of claim 1, the communication device including at least one of a cellular telephone, a smart telephone, a tablet computer, an e-book device, a personal digital assistant, a handheld computer, a laptop computer, a desktop computer, a video telephone, a satellite telephone, and a landline telephone.

13. The apparatus of claim 1, further comprising:
a router configured to form a local area network interconnecting the communication device, patient monitoring device, and therapy delivery device, wherein the router is also configured to provide access to the communication network outside the home or home-like environment.

14. The apparatus of claim 1, the therapy delivery device comprising:
an enclosure including at least one cartridge receptacle, each cartridge receptacle configured to receive a therapy cartridge, each therapy cartridge configured to hold a quantity of some therapy for medical treatment of some patient, each therapy cartridge including identifying information;
a cartridge sensing device for each cartridge receptacle, each cartridge sensing device configured to detect the identifying information associated with a corresponding therapy cartridge received by the cartridge receptacle;
an actuator for each cartridge receptacle, each actuator configured to control the therapy cartridge received by the corresponding cartridge receptacle to release the prescribed dosage of the prescribed therapy;
a collection tray disposed in a tray receptacle and configured to collect the prescribed dosage of the prescribed therapy for delivery to the patient;
a dispensing path in fluidic communication with the at least one cartridge receptacle and collection tray, the dispensing path configured to direct the prescribed dosage of the prescribed therapy from the corresponding cartridge receptacle to the collection tray after release of the prescribed therapy from the therapy cartridge;
a compliance sensor disposed in relation to the collection tray to detect compliance information indicative of patient compliance or non-compliance with the prescribed therapy in conjunction with the prescribed dosage; and
a controller in operative communication with the cartridge sensing device, actuator, compliance sensor, and communication device, wherein the controller is configured to operate in a coordinated manner with the communication device such that the inventory of the prescribed therapy for medical treatment of the patient is held and the prescribed dosage is properly delivered to the patient.

15. The apparatus of claim 14 wherein the identifying information associated with each therapy cartridge includes at least one of 1) the prescribed therapy held by the cartridge, 2) the patient for which the therapy is prescribed, and 3) the quantity of the therapy originally held by the cartridge.

16. The apparatus of claim 14, the therapy delivery device comprising:
a travel box disposed in a travel receptacle and configured to collect one or more prescribed dosages of the prescribed therapy over a patient-specified travel time for delivery to the patient;
a travel sensor in operative communication with the controller and disposed in relation to the travel box to detect compliance information indicative of patient compliance or non-compliance with the one or more prescribed dosages;
wherein the dispensing path is adjustable for directing the prescribed therapy from the corresponding cartridge receptacle to the collection tray or the travel box;
wherein the user interface is configured to allow the patient to specify the travel time and request delivery of the prescribed therapy to the travel box;
wherein the communication device is configured to control the therapy delivery device to dispense the one or more prescribed dosages of the prescribed therapy to the travel box.

17. A method for enhancing home healthcare, comprising:
receiving information associated with a prescribed therapy for medical treatment of a patient using a therapy delivery device in a home or home-like environment, wherein the information associated with the prescribed therapy is received at a communication device and at least temporarily stored in a local storage device;
receiving an inventory of the prescribed therapy at the therapy delivery device, wherein the therapy delivery device is configured to hold the inventory and to selectively deliver a prescribed dosage of the prescribed therapy to the patient;
determining a prescribed dosage of the prescribed therapy needs to be delivered to the patient based at least in part on the information associated with the prescribed therapy;
controlling the therapy delivery device from the communication device to dispense the prescribed dosage of the prescribed therapy from the inventory to a collection tray associated with the therapy delivery device in accordance with a predetermined schedule; and
providing an alert indication at a user interface associated with the communication device to indicate the prescribed dosage of the prescribed therapy is dispensed to the collection tray and ready for removal.

18. The method of claim 17 wherein the information associated with the prescribed therapy is received by the communication device from an authorized party via the user interface.

19. The method of claim 17 wherein the communication device is configured to provide a communication interface with a communication network outside the home or home-like environment to enable establishment of a communication session to/from another communication device associated with another party.

20. The method of claim 19 wherein the information associated with the prescribed therapy is received by the communication device via the communication network in a communication session from a healthcare provider associated with medical treatment of the patient.

21. The method of claim 19, further comprising:
receiving a communication session at the communication device from an authorized party via the communication network;
parsing content of the communication session;
identifying an update to the prescribed therapy based at least in part on the parsed content; and
updating the information associated with the prescribed therapy stored in the local storage device based at least in part on the content of the communication session.

22. The method of claim 17, further comprising:
receiving the inventory for the prescribed therapy in a therapy cartridge at a cartridge receptacle of an enclosure for the therapy delivery device, the enclosure including at least one cartridge receptacle, the therapy cartridge configured to hold a quantity of the prescribed therapy for medical treatment of the patient, each therapy cartridge including identifying information;
detecting the identifying information associated with the therapy cartridge at a cartridge sensing device;
controlling an actuator associated with the therapy cartridge and corresponding cartridge receptacle to release the prescribed dosage of the prescribed therapy;
collecting the prescribed dosage of the prescribed therapy in a collection tray associated with the therapy delivery device for delivery to the patient, wherein a dispensing path in fluidic communication with the cartridge receptacle and collection tray is configured to direct the prescribed dosage of the prescribed therapy from the corresponding cartridge receptacle to the collection tray after release of the prescribed therapy from the therapy cartridge; and
detecting compliance information indicative of patient compliance or non-compliance with the prescribed therapy in conjunction with the prescribed dosage at a compliance sensor disposed in relation to the collection tray.

23. The method of claim 22, wherein the detecting of the compliance information comprising at least one of:
detecting removal of the collection tray from the therapy delivery device after the prescribed dosage of the prescribed therapy is dispensed;
detecting return of the collection tray to the therapy delivery device after removal of the collection tray;
verifying the prescribed dosage dispensed into the collection tray is no longer present; and
detecting activation of an acknowledgement control that the prescribed dosage delivered by the therapy delivery device was taken by the patient.

24. The method of claim 22, further comprising:
receiving a request for a travel box with the prescribed therapy at the user interface, wherein the request includes a travel time over which the travel box is expected to be used, wherein the travel box is associated with the therapy delivery device;
adjusting the dispensing path to direct the prescribed therapy from the cartridge receptacle to the travel box instead of the collection tray;
collecting one or more prescribed dosages of the prescribed therapy in the travel box for delivery to the patient, wherein the amount of prescribed dosages is based at least in part on the travel time; and
detecting compliance information indicative of patient compliance or non-compliance with the prescribed therapy in conjunction with the one or more prescribed dosages at a travel sensor disposed in relation to the travel box.

25. A method for enhancing home healthcare, comprising:
receiving information associated with a physiological condition of a patient and with use of a patient monitoring device in a home or home-like environment to monitor the physiological condition, wherein the information is received at a communication device and at least temporarily stored in a local storage device;
determining a measurement of the physiological condition of the patient needs to be obtained based at least in part on the information associated with the physiological condition;
providing an alert indication at a user interface associated with the communication device to indicate the patient monitoring device needs to be used to obtain the measurement of the physiological condition of the patient;
controlling the user interface and the patient monitoring device from the communication device to set up the patient monitoring device for the needed measurement; and
obtaining the measurement of the physiological condition of the patent from the patient monitoring device at the communication device.

26. The method of claim 21 wherein the communication device is configured to provide a communication interface with a communication network outside the home or home-like environment to enable establishment of a communication session to/from another communication device associated with another party.

27. The method of claim 26, further comprising:
receiving a communication session at the communication device from an authorized party via the communication network;
parsing content of the communication session;
identifying an update to the information associated with the physiological condition based at least in part on the parsed content; and
updating the information associated with the physiological condition stored in the local storage device based at least in part on the content of the communication session.

28. The method of claim 26, further comprising:
controlling the user interface and the patient monitoring device from the communication device to selectively obtain measurements of the physiological condition of the patient from the patient monitoring device at the communication device; and
at least temporarily storing the physiological measurements in the local storage device.
